(19) United States
(12) Patent Application Publication
(10) Pub. No.: US 2025/0039380 A1
(43) Pub. Date: Jan. 30, 2025

(54) SUBBLOCK CODING INFERENCE IN VIDEO CODING

(71) Applicant: GUANGDONG OPPO MOBILE TELECOMMUNICATIONS CORP., LTD., Dongguan (CN)

(72) Inventors: Jonathan GAN, Palo Alto, CA (US); Yue YU, Palo Alto, CA (US)

(21) Appl. No.: 18/919,243

(22) Filed: Oct. 17, 2024

Related U.S. Application Data
(63) Continuation of application No. PCT/US2023/066351, filed on Apr. 28, 2023.
(60) Provisional application No. 63/363,804, filed on Apr. 28, 2022.
(60) Provisional application No. 63/364,713, filed on May 13, 2022.

(51) Int. Cl. H04N 19/12; H04N 19/167; H04N 19/176

(52) U.S. Cl. CPC H04N 19/12; H04N 19/167; H04N 19/176

(57) ABSTRACT

A video decoder decodes a current transform block from a video bitstream. For a transform block encoded with regular residual coding, when a subblock flag sb_coded_flag is not present, the decoder infers the flag to be 1 if the subblock is a DC subblock and/or the last subblock in the transform block containing a non-zero coefficient level. Otherwise, sb_coded_flag is inferred to be 0. For a transform block encoded with regular residual coding, when the sb_coded_flag is present, the decoder determines a context index for an arithmetic decoding process based on the sb_coded_flag of previous subblocks and decodes the sb_coded_flag of the subblock using the arithmetic decoding process. The decoder decodes the transform block based on the determined sb_coded_flag.

### CROSS-REFERENCE TO RELATED APPLICATIONS

This application is a continuation application of International Patent Application No. PCT/US2023/066351, filed on Apr. 28, 2023, which claims the benefit of priorities to U.S. Provisional Application No. 63/363,804, entitled “Inference Rules for Subblock Flags,” filed on Apr. 28, 2022, and U.S. Provisional Application No. 63/364,713, entitled “Inference Rules for Subblock Flags,” filed on May 13, 2022, all of which are hereby incorporated in their entirety by this reference.

### BACKGROUND

The ubiquitous camera-enabled devices, such as smartphones, tablets, and computers, have made it easier than ever to capture videos or images. However, the amount of data for even a short video can be substantially large. Video coding technology (including video encoding and decoding) allows video data to be compressed into smaller sizes thereby allowing various videos to be stored and transmitted. Video coding has been used in a wide range of applications, such as digital TV broadcast, video transmission over the internet and mobile networks, real-time applications (e.g., video chat, video conferencing), DVD and Blu-ray discs, and so on. To reduce the storage space for storing a video and/or the network bandwidth consumption for transmitting a video, it is desired to improve the efficiency of the video coding scheme.

### SUMMARY

Some embodiments involve inferring subblock coding strategy in video coding. In one example, a method for decoding a video bitstream, comprising determining a flag sb_coded_flag for a subblock of a current transform block. Determining the flag sb_coded_flag includes determining whether a first flag specifying whether a transform skip is applied to the transform block is 0 or a second flag specifying whether a transform skip residual coding process is disabled is equal to 1; in response to determining that the first flag is equal to 0 or the second flag is equal to 1 and determining that the flag sb_coded_flag for the subblock is not present, inferring the flag sb_coded_flag for the subblock to be a first value in response to determining one or more conditions are true, and inferring the flag sb_coded_flag for the subblock to be a second value in response to determining that the conditions are not true. The conditions include a first condition that the subblock is a DC subblock and a second condition that the subblock is a last subblock in the transform block containing a non-zero coefficient level. The flag sb_coded_flag having the second value indicates that all values of transform coefficient levels of the subblock can be inferred to be zero. In response to determining that the first flag is equal to 0 or the second flag is equal to 1 and determining that the flag sb_coded_flag for the subblock is present, the method further includes determining a context index for an arithmetic coding process used for decoding the flag sb_coded_flag for the subblock based, at least in part, upon the flags sb_coded_flag of previous subblocks, and decoding the flag sb_coded_flag for the subblock according to the arithmetic decoding process with the determined context index. The method also includes decoding the transform block by decoding at least a portion of the bitstream based on the determined flag sb_coded_flag.

In another example, a non-transitory computer-readable medium has program code that is stored thereon, the program code executable by one or more processing devices for performing operations. The operations include decoding a video bitstream, comprising determining a flag sb_coded_flag for a subblock of a current transform block. Determining the flag sb_coded_flag includes determining whether a first flag specifying whether a transform skip is applied to the transform block is 0 or a second flag specifying whether a transform skip residual coding process is disabled is equal to 1; in response to determining that the first flag is equal to 0 or the second flag is equal to 1 and determining that the flag sb_coded_flag for the subblock is not present, inferring the flag sb_coded_flag for the subblock to be a first value in response to determining one or more of conditions are true, and inferring the flag sb_coded_flag for the subblock to be a second value in response to determining that the conditions are not true. The conditions include a first condition that the subblock is a DC subblock and a second condition that the subblock is a last subblock in the transform block containing a non-zero coefficient level. The flag sb_coded_flag having the second value indicates that all values of transform coefficient levels of the subblock can be inferred to be zero. In response to determining that the first flag is equal to 0 or the second flag is equal to 1 and determining that the flag sb_coded_flag for the subblock is present, the operations further include determining a context index for an arithmetic coding process used for decoding the flag sb_coded_flag for the subblock based, at least in part, upon the flags sb_coded_flag of previous subblocks, and decoding the flag sb_coded_flag for the subblock according to the arithmetic decoding process with the determined context index. The operations also include decoding the transform block by decoding at least a portion of the bitstream based on the determined flag sb_coded_flag.

In yet another example, a system includes a processing device and a non-transitory computer-readable medium communicatively coupled to the processing device. The processing device is configured to execute program code stored in the non-transitory computer-readable medium and thereby perform operations. The operations include decoding a video bitstream, comprising determining a flag sb_coded_flag for a subblock of a current transform block. Determining the flag sb_coded_flag includes determining whether a first flag specifying whether a transform skip is applied to the transform block is 0 or a second flag specifying whether a transform skip residual coding process is disabled is equal to 1; in response to determining that the first flag is equal to 0 or the second flag is equal to 1 and determining that the flag sb_coded_flag for the subblock is not present, inferring the flag sb_coded_flag for the subblock to be a first value in response to determining one or more of conditions are true, and inferring the flag sb_coded_flag for the subblock to be a second value in response to determining that the conditions are not true. The conditions include a first condition that the subblock is a DC subblock and a second condition that the subblock is a last subblock in the transform block containing a non-zero coefficient level. The flag sb_coded_flag having the second value indicates that all values of transform coefficient levels of the subblock can be inferred to be zero. In response to determining that the first flag is equal to 0 or the second flag is equal to 1 and determining that the flag sb_coded_flag for the subblock is present, the operations further include determining a context index for an arithmetic coding process used for decoding the flag sb_coded_flag for the subblock based, at least in part, upon the flags sb_coded_flag of previous subblocks, and decoding the flag sb_coded_flag for the subblock according to the arithmetic decoding process with the determined context index. The operations also include decoding the transform block by decoding at least a portion of the bitstream based on the determined flag sb_coded_flag.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram showing an example of a video encoder configured to implement embodiments presented herein.

FIG. 2 is a block diagram showing an example of a video decoder configured to implement embodiments presented herein.

FIG. 3 depicts an example of a coding tree unit division of a picture in a video, according to some embodiments of the present disclosure.

FIG. 4 depicts an example of a coding unit division of a coding tree unit, according to some embodiments of the present disclosure.

FIG. 5 depicts an example of a coding block with a pre-determined scanning order and coding order for the coding block, according to some embodiments of the present disclosure.

FIG. 6 depicts an example of a process for decoding a frame of a video according to some embodiments of the present disclosure.

FIG. 7 depicts an example of a process for determining the value of subblock flag for each subblock in a transform block, according to some embodiments of the present disclosure.

FIG. 8 depicts an example of a computing system that can be used to implement some embodiments of the present disclosure.

### DETAILED DESCRIPTION

Various embodiments provide mechanisms for inferring subblock coding strategy in video coding. As discussed above, more and more video data are being generated, stored, and transmitted. It is beneficial to increase the efficiency of the video coding technology thereby using less data to represent a video without compromising the visual quality of the decoded video. One way to improve the coding efficiency is through entropy coding to compress data associated with the video, including subblock flags, into a binary bitstream using as few bits as possible. In context-based binary arithmetic entropy coding, the coding engine estimates a context probability indicating the likelihood of the next binary symbol having the value one. Such estimation requires an initial context probability estimate. The initial context probability estimate for the entropy coding model for the subblock flags can be derived based on the subblock flags from neighboring subblocks of a current subblock.

A subblock flag sb_coded_flag indicates whether the corresponding subblock in a transform block contains non-zero transformed coefficient levels. For example, if the transformed coefficient levels in a subblock are all zero, the subblock does not need to be encoded and the subblock flag can be set to 0. In some examples, the subblock flags for some subblocks are not signaled and thus need to be derived or inferred at the decoder side. However, the inference rules in an earlier version of the Versatile Video Coding (VVC) standard are inaccurate, as the values of some subblock flags are inferred inconsistently with the transform coefficient levels contained by the corresponding subblocks. This inconsistency will lead to an estimation error for the initial context state of the entropy coding model for the subblock flags thereby reducing the coding efficiency.

In some embodiments, the video decoder can determine the value of the subblock flag for a subblock in a transform block as follows. The decoder can determine whether a first flag transform_skip_flag[x0][y0][cIdx] is 0 or a second flag sh_ts_residual_coding_disabled_flag is equal to 1. If so (which indicates that the transform block is encoded with a regular residual coding process), the decoder can determine, for a subblock whose sb_coded_flag is not present in the coded bitstream, whether one or more of the two conditions are true. The two conditions include a first condition that the subblock is a DC subblock and a second condition that the subblock is the last subblock in the transform block containing a non-zero coefficient level. If one or more of the two conditions are true, the decoder can infer the subblock flag for the subblock to be 1 indicating that the current subblock has a non-zero coefficient. Otherwise, the subblock flag for the subblock can be inferred to be 0 indicating that all transform coefficient levels in the subblock can be inferred to be 0. If the first flag transform_skip_flag[x0][y0][cIdx] is 1 and a second flag sh_ts_residual_coding_disabled_flag is equal to 0 (which indicates that the transform block is encoded with a transform skip residual coding process), the decoder can infer, for a subblock whose sb_coded_flag is not present in the coded bitstream, the flag sb_coded_flag be 1.

As described herein, some embodiments provide improvements in video coding efficiency by providing improved inference rules for subblock flags. With the proposed inference rules, the values of subblock flags can be inferred consistently with the transform coefficient levels contained by the corresponding subblocks. The inferred sb_coded_flag values more accurately reflect the probability of the sb_coded_flags, thereby providing a more accurate estimate of the initial context value for the entropy coding model. As a result, the coding efficiency can be improved. The techniques can be an effective coding tool in future video coding standards.

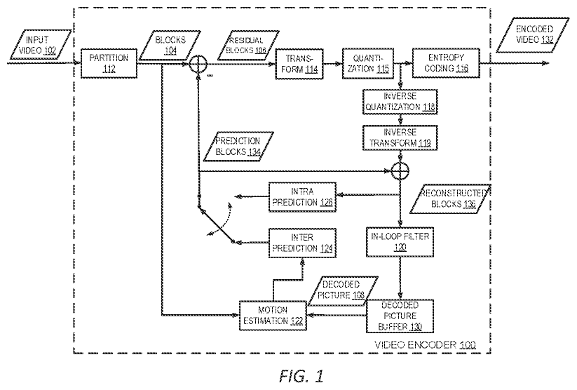

Referring now to the drawings, FIG. 1 is a block diagram showing an example of a video encoder 100 configured to implement embodiments presented herein. In the example shown in FIG. 1, the video encoder 100 includes a partition module 112, a transform module 114, a quantization module 115, an inverse quantization module 118, an inverse transform module 119, an in-loop filter module 120, an intra prediction module 126, an inter prediction module 124, a motion estimation module 122, a decoded picture buffer 130, and an entropy coding module 116.

The input to the video encoder 100 is an input video 102 containing a sequence of pictures (also referred to as frames or images). In a block-based video encoder, for each of the pictures, the video encoder 100 employs a partition module 112 to partition the picture into blocks 104, and each block contains multiple pixels. The blocks may be macroblocks, coding tree units, coding units, prediction units, and/or prediction blocks. One picture may include blocks of different sizes and the block partitions of different pictures of the video may also differ. Each block may be encoded using different predictions, such as intra prediction or inter prediction or intra and inter hybrid prediction.

Usually, the first picture of a video signal is an intra-predicted picture, which is encoded using only intra prediction. In the intra prediction mode, a block of a picture is predicted using only data from the same picture. A picture that is intra-predicted can be decoded without information from other pictures. To perform the intra-prediction, the video encoder 100 shown in FIG. 1 can employ the intra prediction module 126. The intra prediction module 126 is configured to use reconstructed samples in reconstructed blocks 136 of neighboring blocks of the same picture to generate an intra-prediction block (the prediction block 134). The intra prediction is performed according to an intra-prediction mode selected for the block. The video encoder 100 then calculates the difference between block 104 and the intra-prediction block 134. This difference is referred to as residual block 106.

To further remove the redundancy from the block, the residual block 106 is transformed by the transform module 114 into a transform domain by applying a transform to the samples in the block. Examples of the transform may include, but are not limited to, a discrete cosine transform (DCT) or discrete sine transform (DST). The transformed values may be referred to as transform coefficients representing the residual block in the transform domain. In some examples, the residual block may be quantized directly without being transformed by the transform module 114. This is referred to as a transform skip mode.

The video encoder 100 can further use the quantization module 115 to quantize the transform coefficients to obtain quantized coefficients. Quantization includes dividing a sample by a quantization step size followed by subsequent rounding, whereas inverse quantization involves multiplying the quantized value by the quantization step size. Such a quantization process is referred to as scalar quantization. Quantization is used to reduce the dynamic range of video samples (transformed or non-transformed) so that fewer bits are used to represent the video samples.

The quantization of coefficients/samples within a block can be done independently and this kind of quantization method is used in some existing video compression standards, such as H.264, and HEVC. For an N-by-M block, a specific scan order may be used to convert the 2D coefficients of a block into a 1-D array for coefficient quantization and coding. Quantization of a coefficient within a block may make use of the scan order information. For example, the quantization of a given coefficient in the block may depend on the status of the previous quantized value along the scan order. In order to further improve the coding efficiency, more than one quantizer may be used. Which quantizer is used for quantizing a current coefficient depends on the information preceding the current coefficient in encoding/decoding scan order. Such a quantization approach is referred to as dependent quantization.

The degree of quantization may be adjusted using the quantization step sizes. For instance, for scalar quantization, different quantization step sizes may be applied to achieve finer or coarser quantization. Smaller quantization step sizes correspond to finer quantization, whereas larger quantization step sizes correspond to coarser quantization. The quantization step size can be indicated by a quantization parameter (QP). The quantization parameters are provided in the encoded bitstream of the video such that the video decoder can apply the same quantization parameters for decoding.

The quantized samples are then coded by the entropy coding module 116 to further reduce the size of the video signal. The entropy encoding module 116 is configured to apply an entropy encoding algorithm to the quantized samples. In some examples, the quantized samples are binarized into binary bins and coding algorithms further compress the binary bins into bits. Examples of the binarization methods include, but are not limited to, truncated Rice (TR) and limited k-th order Exp-Golomb (EGk) binarization. To improve the coding efficiency, a method of history-based Rice parameter derivation is used, where the Rice parameter derived for a transform unit (TU) is based on a variable obtained or updated from previous TUs. Examples of the entropy encoding algorithm include, but are not limited to, a variable length coding (VLC) scheme, a context adaptive VLC scheme (CAVLC), an arithmetic coding scheme, a binarization, a context-adaptive binary arithmetic coding (CABAC), syntax-based context-adaptive binary arithmetic coding (SBAC), probability interval partitioning entropy (PIPE) coding, or other entropy encoding techniques. The entropy-coded data is added to the bitstream of the output encoded video 132.

As discussed above, reconstructed blocks 136 from neighboring blocks are used in the intra-prediction of blocks of a picture. Generating the reconstructed block 136 of a block involves calculating the reconstructed residuals of this block. The reconstructed residual can be determined by applying inverse quantization and inverse transform to the quantized residual of the block. The inverse quantization module 118 is configured to apply the inverse quantization to the quantized samples to obtain de-quantized coefficients. The inverse quantization module 118 applies the inverse of the quantization scheme applied by the quantization module 115 by using the same quantization step size as the quantization module 115. The inverse transform module 119 is configured to apply the inverse transform of the transform applied by the transform module 114 to the de-quantized samples, such as inverse DCT or inverse DST. The output of the inverse transform module 119 is the reconstructed residuals for the block in the pixel domain. The reconstructed residuals can be added to the prediction block 134 of the block to obtain a reconstructed block 136 in the pixel domain. For blocks where the transform is skipped, the inverse transform module 119 is not applied to those blocks. The de-quantized samples are the reconstructed residuals for the blocks.

Blocks in subsequent pictures following the first intra-predicted picture can be coded using either inter prediction or intra prediction. In inter-prediction, the prediction of a block in a picture is from one or more previously encoded video pictures. To perform inter prediction, the video encoder 100 uses an inter prediction module 124. The inter prediction module 124 is configured to perform motion compensation for a block based on the motion estimation provided by the motion estimation module 122.

The motion estimation module 122 compares a current block 104 of the current picture with decoded reference pictures 108 for motion estimation. The decoded reference pictures 108 are stored in a decoded picture buffer 130. The motion estimation module 122 selects a reference block from the decoded reference pictures 108 that best matches the current block. The motion estimation module 122 further identifies an offset between the position (e.g., x, y coordinates) of the reference block and the position of the current block. This offset is referred to as the motion vector (MV) and is provided to the inter prediction module 124. In some cases, multiple reference blocks are identified for the block in multiple decoded reference pictures 108. Therefore, multiple motion vectors are generated and provided to the inter prediction module 124.

The inter prediction module 124 uses the motion vector(s) along with other inter-prediction parameters to perform motion compensation to generate a prediction of the current block, i.e., the inter prediction block 134. For example, based on the motion vector(s), the inter prediction module 124 can locate the prediction block(s) pointed to by the motion vector(s) in the corresponding reference picture(s). If there are more than one prediction block, these prediction blocks are combined with some weights to generate a prediction block 134 for the current block.

For inter-predicted blocks, the video encoder 100 can subtract the inter-prediction block 134 from the block 104 to generate the residual block 106. The residual block 106 can be transformed, quantized, and entropy coded in the same way as the residuals of an intra-predicted block discussed above. Likewise, the reconstructed block 136 of an inter-predicted block can be obtained through inverse quantizing, inverse transforming the residual, and subsequently combining with the corresponding prediction block 134.

To obtain the decoded picture 108 used for motion estimation, the reconstructed block 136 is processed by an in-loop filter module 120. The in-loop filter module 120 is configured to smooth out pixel transitions thereby improving the video quality. The in-loop filter module 120 may be configured to implement one or more in-loop filters, such as a de-blocking filter, or a sample-adaptive offset (SAO) filter, or an adaptive loop filter (ALF), etc.

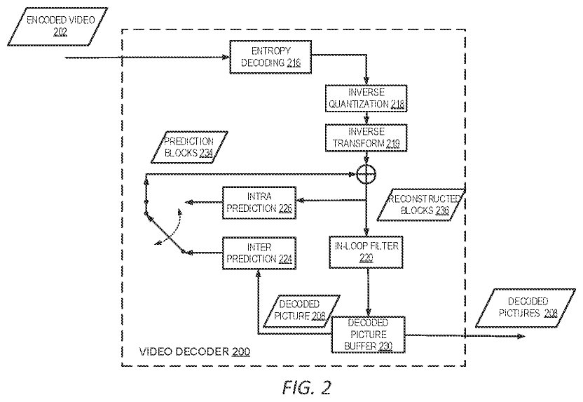

FIG. 2 depicts an example of a video decoder 200 configured to implement embodiments presented herein. The video decoder 200 processes an encoded video 202 in a bitstream and generates decoded pictures 208. In the example shown in FIG. 2, the video decoder 200 includes an entropy decoding module 216, an inverse quantization module 218, an inverse transform module 219, an in-loop filter module 220, an intra prediction module 226, an inter prediction module 224, and a decoded picture buffer 230.

The entropy decoding module 216 is configured to perform entropy decoding of the encoded video 202. The entropy decoding module 216 decodes the quantized coefficients, coding parameters including intra prediction parameters and inter prediction parameters, and other information. In some examples, the entropy decoding module 216 decodes the bitstream of the encoded video 202 to binary representations and then converts the binary representations to the quantization levels for the coefficients. The entropy-decoded coefficients are then inverse quantized by the inverse quantization module 218 and subsequently inverse transformed by the inverse transform module 219 to the pixel domain. The inverse quantization module 218 and the inverse transform module 219 function similarly to the inverse quantization module 118 and the inverse transform module 119, respectively, as described above with respect to FIG. 1. The inverse-transformed residual block can be added to the corresponding prediction block 234 to generate a reconstructed block 236. For blocks where the transform is skipped, the inverse transform module 219 is not applied to those blocks. The de-quantized samples generated by the inverse quantization module 118 are used to generate the reconstructed block 236.

The prediction block 234 of a particular block is generated based on the prediction mode of the block. If the coding parameters of the block indicate that the block is intra predicted, the reconstructed block 236 of a reference block in the same picture can be fed into the intra prediction module 226 to generate the prediction block 234 for the block. If the coding parameters of the block indicate that the block is inter-predicted, the prediction block 234 is generated by the inter prediction module 224. The intra prediction module 226 and the inter prediction module 224 function similarly to the intra prediction module 126 and the inter prediction module 124 of FIG. 1, respectively.

As discussed above with respect to FIG. 1, the inter prediction involves one or more reference pictures. The video decoder 200 generates the decoded pictures 208 for the reference pictures by applying the in-loop filter module 220 to the reconstructed blocks of the reference pictures. The decoded pictures 208 are stored in the decoded picture buffer 230 for use by the inter prediction module 224 and also for output.

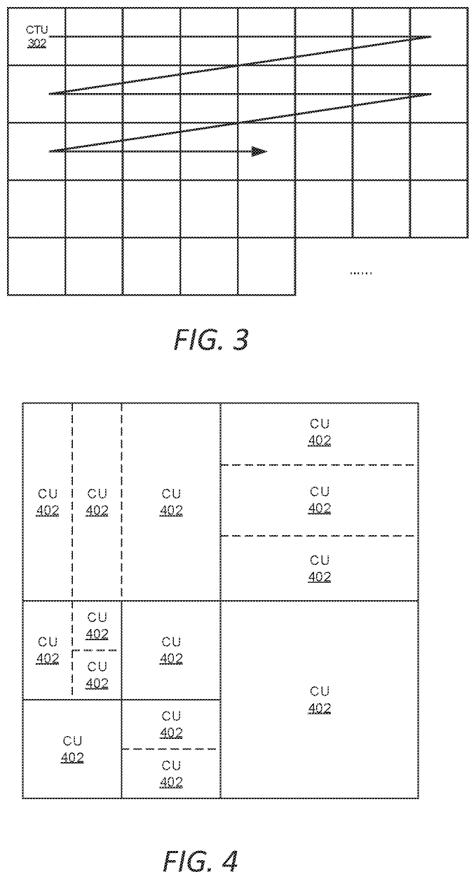

Referring now to FIG. 3, FIG. 3 depicts an example of a coding tree unit division of a picture in a video, according to some embodiments of the present disclosure. As discussed above with respect to FIGS. 1 and 2, to encode a picture of a video, the picture is divided into blocks, such as the CTUs (Coding Tree Units) 302 in VVC, as shown in FIG. 3. For example, the CTUs 302 can be blocks of 128×128 pixels. The CTUs are processed according to an order, such as the order shown in FIG. 3. In some examples, each CTU 302 in a picture can be partitioned into one or more CUs (Coding Units) 402 as shown in FIG. 4, which can be further partitioned into prediction units or transform units (TUs) for prediction and transformation. Depending on the coding schemes, a CTU 302 may be partitioned into CUs 402 differently. For example, in VVC, the CUs 402 can be rectangular or square, and can be coded without further partitioning into prediction units or transform units. Each CU 402 can be as large as its root CTU 302 or be subdivisions of a root CTU 302 as small as 4×4 blocks. As shown in FIG. 4, a division of a CTU 302 into CUs 402 in VVC can be quadtree splitting or binary tree splitting or ternary tree splitting. In FIG. 4, solid lines indicate quadtree splitting and dashed lines indicate binary or ternary tree splitting.

### Residual Coding Processes

In hybrid video coding systems, efficient compression performance may be achieved by selecting from a variety of prediction tools. In VVC, prediction is performed at the CU level. Each coding unit is composed of one or more coding blocks (CBs) corresponding to the color components of the video signal. For example, if the video signal has YCbCr chroma format, then each coding unit is composed of one luma coding block and two chroma coding blocks. A prediction unit (PU) with the same number of blocks and samples as the CU is derived by applying a selected prediction tool. Then if the prediction is accurate, the difference between a current coding block of samples and the prediction block (referred to as residual) consists mostly of small magnitude values and is easier to encode than the original samples of the CB. Each residual block may be divided into one or more transform blocks (TBs) depending on constraints of the hardware. Encoding a single TB is most efficient for compression of the residual data, but it may be necessary to divide the residual block if it is larger than the maximum transform size supported by VVC.

When the video signal contains camera captured (“natural”) content, the residual in each TB may be further compacted by applying a transform such as an integerized version of the discrete cosine transform. Lossy compression is typically achieved by quantizing the transformed coefficients. The magnitudes of the quantized coefficients, which may be referred to as transform coefficient levels, as well as the signs of the quantized coefficients are encoded to the bitstream by a residual coding process. For video signals containing screen captured content, the residual may not benefit from application of a transform. For example, if the transformed coefficients have high spatial frequency coefficients with relatively high magnitude, then the energy of the residual is not compacted into a small number of coefficients by the transform. In such cases the transform may be skipped and the residual samples are quantized directly.

The statistical distribution of transform coefficients is typically different to the statistical distribution of transform-skipped coefficients. To efficiently code both transform and transform-skipped coefficients, in VVC two residual coding processes are available, namely a regular residual coding (RRC) process and a transform skip residual coding (TSRC) process. RRC is selected for CUs when a transform was used. TSRC is selected for CUs when a transform was skipped and TSRC is available. TSRC is not available if a slice header flag sh_ts_residual_coding_disabled_flag is set to 1. In such case, RRC is used for both transform and transform-skipped CUs.

Both residual coding processes firstly collect coefficients into sets (e.g., 16 samples) of smaller subblocks, called coded subblocks. As described above, it is expected that the residual consists mostly of small magnitude values due to accurate prediction. After quantization, the residual is expected to consist mostly of zero-valued coefficients. The coded subblock structure enables efficient signaling of large amounts of zero-valued coefficients. Each coded subblock of coefficients is associated with a subblock flag syntax element, sb_coded_flag. If all coefficients in the subblock have a value of 0, then sb_coded_flag is set to 0. For this type of subblock, only the flag for the subblock needs to be decoded from the bitstream, as the values of the all the coefficients in the subblock can be inferred to be 0.

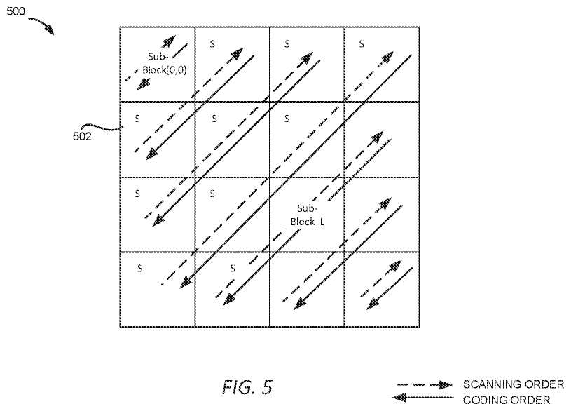

The sb_coded_flag may itself be signaled or inferred. In RRC, the position of the last significant coefficient in the TB is signaled before any subblock flags. The last significant coefficient is the last non-zero coefficient in the order of a two-level hierarchical diagonal scan, where the first level is a diagonal scan across the subblocks of the CU, and the second level is a diagonal scan through the coefficients of a subblock. The coefficient level coding is performed in a reverse scan order starting from the position of last significant coefficient. FIG. 5 depicts an example of a coding block with a pre-determined scanning order and coding order for the coding block, according to some embodiments of the present disclosure. In this example, a transform block 500 contains 16 subblocks 502 and each subblock may have 4×4 samples. Dotted lines show the scanning order, and the solid lines shows the coding order. The scanning order is from top left to the bottom right and the coding order is the reverse of the scanning order from the bottom right to the top left. In some examples, the encoding starts at the subblock containing the last significant coefficient of the coding block, such as Subblock_L shown in FIG. 5.

The subblock containing the last significant coefficient is guaranteed to contain at least one significant coefficient, so its associated subblock flag is not signaled but inferred to be 1. The first subblock Subblock (0,0) in the diagonal scan order contains transformed coefficients corresponding to the lowest spatial frequencies. The first subblock is not guaranteed to contain a significant coefficient, but its associated subblock flag is also not signaled and inferred to be 1, as the lowest spatial frequencies are most likely to contain significant coefficients. Subblock flags associated with subblocks between the first subblock and the subblock containing the last significant coefficient are signaled. In the example shown in FIG. 5, subblock flags associated with subblocks between subblock (0,0) and subblock_L are signaled. Those subblocks are marked with “S” in FIG. 5. Subblock flags associated with the remaining subblocks of the transform block 500 are not signaled.

In TSRC, no last significant coefficient position is signaled. The coefficient level coding is performed in a scan order starting from the position of (0,0). A subblock flag is signaled for every subblock except potentially the last subblock. The last subblock flag is inferred to be 1 if the signaled subblock flag for every other subblock in the TB was 0. Otherwise, the last subblock is also signaled.

Subblock flags which are signalled are coded as context coded bins by context adaptive binary arithmetic coding (CABAC). Decoding of context coded bins depends on context states, which adapt to the statistics of the syntax element by updating as bins are decoded. VVC keeps track of two states (multi-hypothesis) for each context coded bin. The context states for sb_coded_flag are initialised by deriving a ctxInc value as follows.

Derivation Process of ctxInc for the Syntax Element sb_coded_flag

Inputs to this process are the colour component index cIdx, the luma location (x, y0) specifying the top-left sample of the current transform block relative to the top-left sample of the current picture, the current subblock scan location (xS, yS), the previously decoded bins of the syntax element sb_coded_flag and the binary logarithm of the transform block width log 2TbWidth and the transform block height log 2TbHeight. Output of this process is the variable ctxInc.

The variable csbfCtx is derived using the current location (xS, yS), two previously decoded bins of the syntax element sb_coded_flag in scan order, log 2TbWidth and log 2TbHeight, as follows:
The variables log 2SbWidth and log 2SbHeight are derived as follows:

$$log 2 SbWidth = ( Min ( log 2 TbWidth , log 2 TbHeight ) < 2 ? 1 : 2 ) \qquad ( 1 )$$

$$log 2 SbHeight = log 2 SbWidth \qquad ( 2 )$$

The variables log 2SbWidth and log 2SbHeight are modified as follows:
If log 2TbWidth is less than 2 and cIdx is equal to 0, the following applies

$$log 2 SbWidth = log 2 TbWidth \qquad ( 3 )$$

$$log 2 SbHeight = 4 - log 2 SbWidth \qquad ( 4 )$$

Otherwise, if log 2TbHeight is less than 2 and cIdx is equal to 0, the following applies

$$log 2 SbHeight = log 2 TbHeight \qquad ( 5 )$$

$$log 2 SbWidth = 4 - log 2 SbHeight \qquad ( 6 )$$

The variable csbfCtx is initialized with 0 and modified as follows:
   If transform_skip_flag[x0][y0][cIdx] is equal to 1 and sh_ts_residual_coding_disabled_flag is equal to 0, the following applies:
      When xS is greater than 0, csbfCtx is modified as follows:

$$csbfCtx += sb\_coded \_flag [ x S - 1 ] [ yS ] \qquad ( 7 )$$

When yS is greater than 0, csbfCtx is modified as follows:

$$csbfCtx += sb\_coded \_flag [ xS ] [ yS - 1 ] \qquad ( 8 )$$

Otherwise (transform_skip_flag[x0][y0][cIdx] is equal to 0 or sh_ts_residual_coding_disabled_flag is equal to 1), the following applies:
   When xS is less than (1<<(log 2TbWidth−log 2SbWidth))−1, csbfCtx is modified as follows:

$$csbfCtx += sb\_coded \_flag [ xS + 1 ] [ yS ] \qquad ( 9 )$$

When yS is less than (1<<(log 2TbHeight−log 2SbHeight))−1, csbfCtx is modified as follows:

$$csbfCtx += sb\_coded \_flag [ xS ] [ yS + 1 ] \qquad ( 10 )$$

The context index increment ctxInc is derived using the colour component index cIdx and csbfCtx as follows:
If transform_skip_flag[x0][y0][cIdx] is equal to 1 and sh_ts_residual_coding_disabled_flag is equal to 0, ctxInc is derived as follows:

$$ctxInc = 4 + csbfCtx \qquad ( 11 )$$

Otherwise (transform_skip_flag[x0][y0][cIdx] is equal to 0 or sh_ts_residual_coding_disabled_flag is equal to 1), ctxInc is derived as follows:
   If cIdx is equal to 0, the following applies:

$$ctxInc = Min ( csbfCtx , 1 ) \qquad ( 12 )$$

Otherwise (cIdx is greater than 0), ctxInc is derived as follows:

$$ctxInc = 2 + Min ( csbfCtx , 1 ) \qquad ( 13 )$$

In version 10 draft of VVC (JVET-T2001), a shared inference rule is used for subblock flags in both RRC and TSRC. The semantics for sb_coded_flag are as follows, with the inference rule shown in italics:
sb_coded_flag[xS][yS] specifies the following for the subblock at location (xS, yS) within the current transform block, where a subblock is an array of transform coefficient levels:
When sb_coded_flag[xS][yS] is equal to 0, all transform coefficient levels of the subblock at location (xS, yS) are inferred to be equal to 0.
When sb_coded_flag[xS][yS] is not present, it is inferred to be equal to 1.

In RRC, this means that subblock flags for subblocks after the subblock containing the last significant coefficient are also inferred to be 1. Under this inference rule, in the example shown in FIG. 5, the subblock flags for subblocks not marked with “S” are inferred to be 1. This implies the subblocks not marked with “S” each contain at least one non-zero transform coefficient level. However, the subblocks not marked with “S” do not contain non-zero coefficients. Because the subblocks not marked with “S” precede Subblock_L in coding order, the transform coefficient levels contained by the subblocks not marked with “S” are not signalled and therefore are inferred to have the correct values of 0 regardless of the inferred value of the subblock flags. However, from Eqns. (9), (10), (12) and (13), inferred values of sb_coded_flag may influence the derivation of ctxInc.

More specifically, csbfCtx may be modified by Eqns. (9) and (10), but will take the value of 0 if both sb_coded_flag values corresponding to the subblock to the right (sb_coded_flag[xS+1][yS]) and the subblock below (sb_coded_flag[xS][yS+1]) of the current subblock are 0. If at least one of the sb_coded_flag values corresponding to the subblock to the right or the subblock below the current subblock is 1, then csbfCtx will be incremented to a non-zero value. Then with the inference rule of JVET-T2001 described above and in the example of FIG. 5, if at least one of the subblocks to the right or below the current subblock are not marked with “S”, csbfCtx will be incremented to a non-zero value. Then, when cIdx equals 0 (which means that the current transform block is a luma transform block), ctxInc is determined by Eqn. (12) to be 0 if csbfCtx is 0, and 1 otherwise. When cIdx is greater than 0 (which means that the current transform block is a chroma transform block), ctxInc is determined by Eqn. (13) to be 2 if csbfCtx is 0, and 3 otherwise. Therefore, ctxInc may be determined to a different value because of the inferred value of a sb_coded_flag corresponding to a subblock to the right or below of the current subblock. The context increment ctxInc is adjusted by an offset “ctxIdxOffset” (which offsets to the set of contexts for the sb_coded_flag syntax element and the slice type) to finally determine a context index “ctxIdx”.

As seen in Eqns. (9), (10), (12) and (13), for a particular slice type and colour component, the context index selection gives the opportunity to select between two different context indices based on the value of neighbouring sb_coded_flags. Context adaptation based on previously coded syntax elements exploits spatial correlation with relatively low implementation cost. Each context corresponds to a statistical model for that syntax element which can be maintained and updated independently. The intent of this mechanism for sb_coded_flag is for one context (ctxInc with the value 0 or 2, “Context A”) to be selected when the neighbouring subblocks have no significant coefficients, and another context (ctxInc with the value 1 or 3, “Context B”) to be selected when at least one neighbouring subblock has a significant coefficient. However, with the inference rule of JVET-T2001, “Context B” can still be selected when the neighbouring subblocks have no significant coefficients, as long as one of the neighbouring subblocks has an inferred sb_coded_flag.

Because the inferred values of sb_coded_flag in RRC are inconsistent with the transform coefficient levels contained by the corresponding subblocks, the context initialisation may not be optimal leading to reduced coding efficiency.

To solve the above problems, the semantics for sb_coded_flag can be replaced with the following, with separate inference rules defined for sb_coded_flag in RRC and TSRC. Additions relative to JVET-T2001 are shown in underlines and deletions are shown in strikethrough.
sb_coded_flag[xS][yS] specifies the following for the subblock at location (xS, yS) within the current transform block, where a subblock is an array of numSbCoeff transform coefficient levels:
If transform skip flag[x0][y0][cIdx] is equal to 0 or sh_ts_residual_coding_disabled_flag is equal to 1, the following applies:
   When sb_coded_flag[xS][yS] is not present, it is inferred as follows:
      If one or more of the following conditions are true, sb_coded_flag[xS][yS] is inferred to be equal to 1:
         (xS, yS) is equal to (0,0).
         (xS, yS) is equal to (LastSignificantCoeffX>>log 2SbW, LastSignificantCoeffY>>log 2SbH).
      Otherwise, sb_coded_flag[xS][yS] is inferred to be equal to 0.
   If sb_coded_flag[xS][yS] is equal to 0, all transform coefficient levels of the subblock at location (xS, yS) are inferred to be equal to 0.
   Otherwise (sb_coded_flag[xS][yS] is equal to 1), the following applies:
      If (xS, yS) is equal to (0, 0) and (LastSignificantCoeffX, LastSignificantCoeffY) is not equal to (0, 0), at least one of the sig coeff flag syntax elements is present for the subblock at location (xS, yS).
Otherwise, at least one of the transform coefficient levels of the subblock at location (xS, yS) has a non-zero value.
   Otherwise (transform skip flag[x0][y0][cIdx] is equal to 1 and sh_ts_residual_coding_disabled_flag is equal to 0), the following applies:
   When sb_coded_flag[xS][yS] is not present, it is inferred to be equal to 1.
   If sb_coded_flag[xS][yS] is equal to 0, all transform coefficient levels of the subblock at location (xS, yS) are inferred to be equal to 0.
   Otherwise (sb_coded_flag[xS][yS] is equal to 1), at least one of the transform coefficient levels of the subblock at location (xS, yS) has a non-zero value.

In another example of the embodiment, the semantics for sb_coded_flag are replaced with the following. Additions relative to JVET-T2001 are underlined and deletions are shown in strikethrough.
sb_coded_flag[xS][yS] specifies the following for the subblock at location (xS, yS) within the current transform block, where a subblock is an array of transform coefficient levels:
When transform skip flag[x0][y0][cIdx] is equal to 0 or
sh_ts_residual_coding_disabled_flag is equal to 1, the following applies:
   If sb_coded_flag[xS][yS] is equal to 0, the transform coefficient levels of the subblock at location (xS, yS) are inferred to be equal to 0.
   Otherwise (sb_coded_flag[xS][yS] is equal to 1), the following applies:
      If (xS, yS) is equal to (0, 0) and (LastSignificantCoeffX, LastSignificantCoeffY) is not equal to (0, 0), at least one of the sig coeff flag syntax elements is present for the subblock at location (xS, yS).
      Otherwise, at least one of the transform coefficient levels of the subblock at location (xS, yS) has a non-zero value.
   When sb_coded_flag[xS][yS] is not present, it is inferred as follows:
      If one or more of the following conditions are true, sb_coded_flag[xS][yS] is inferred to be equal to 1:
         (xS, yS) is equal to (0,0).
         (xS, yS) is equal to (LastSignificantCoeffX>>log 2SbW, LastSignificantCoeffY>>log 2SbH).
   Otherwise, sb_coded_flag[xS][yS] is inferred to be equal to 0.
Otherwise (transform skip flag[x0][y0][cIdx] is equal to 1 and
sh_ts_residual_coding_disabled_flag is equal to 0), the following applies:
   If sb_coded_flag[xS][yS] is equal to 0, all transform coefficient levels of the subblock at location (xS, yS) are inferred to be equal to 0.
   Otherwise (sb_coded_flag[xS][yS] is equal to 1), at least one of the transform coefficient levels of the subblock at location (xS, yS) has a non-zero value.
   When sb_coded_flag[xS][yS] is not present, it is inferred to be equal to 1.

In another example of the embodiment, the semantics for sb_coded_flag are replaced with the following. Additions relative to JVET-T2001 are underlined and deletions are shown in strikethrough.
sb_coded_flag[xS][yS] specifies the following for the subblock at location (xS, yS) within the current transform block, where a subblock is an array of numSbCoeff transform coefficient levels:
When transform skip flag[x0][y0][cIdx] is equal to 0 or
sh_ts_residual_coding_disabled_flag is equal to 1, the following applies:
   If sb_coded_flag[xS][yS] is equal to 0, the transform coefficient levels of the subblock at location (xS, yS) are inferred to be equal to 0.
   Otherwise (sb_coded_flag[xS][yS] is equal to 1), the following applies:
      If (xS, yS) is equal to (0, 0) and (LastSignificantCoeffX, LastSignificantCoeffY) is not equal to (0, 0), at least one of the sig coeff flag syntax elements is present for the subblock at location (xS, yS).
      Otherwise, at least one of the transform coefficient levels of the subblock at location (xS, yS) has a non-zero value.
   When sb_coded_flag[xS][yS] is not present, it is inferred as follows:
      If one or more of the following conditions are true, sb_coded_flag[xS][yS] is inferred to be equal to 1:
         (xS, yS) is equal to (0, 0).
         (xS, yS) is equal to (LastSignificantCoeffX>>log 2SbW, LastSignificantCoeffY>>log 2SbH).
   Otherwise, sb_coded_flag[xS][yS] is inferred to be equal to 0.
Otherwise (transform skip flag[x0][y0][cIdx] is equal to 1 and
sh_ts_residual_coding_disabled_flag is equal to 0), the following applies:
   If sb_coded_flag[xS][yS] is equal to 0, all transform coefficient levels of the subblock at location (xS, yS) are inferred to be equal to 0.
   Otherwise (sb_coded_flag[xS][yS] is equal to 1), at least one of the transform coefficient levels of the subblock at location (xS, yS) has a non-zero value.
   When sb_coded_flag[xS][yS] is not present, it is inferred to be equal to 1.

In yet another example, the semantics for sb_coded_flag are replaced with the following. Additions relative to JVET-T2001 are underlined and deletions are shown in strikethrough.
sb_coded_flag[xS][yS] specifies the following for the subblock at location (xS, yS) within the current transform block, where a subblock is an array of numSbCoeff transform coefficient levels:
If transform skip flag[x0][y0][cIdx] is equal to 0 or sh_ts_residual_coding_disabled_flag is equal to 1, the following applies:
   When sb_coded_flag[xS][yS] is not present, it is inferred as follows:
      If one or more of the following conditions are true, sb_coded_flag[xS][yS] is inferred to be equal to 1:
         (xS, yS) is equal to (0,0).
         (xS, yS) is equal to (LastSignificantCoeffX>>log 2SbW, LastSignificantCoeffY>>log 2SbH).
      Otherwise, sb_coded_flag[xS][yS] is inferred to be equal to 0.
   If sb_coded_flag[xS][yS] is equal to 0, the transform coefficient levels of the subblock at location (xS, yS) are inferred to be equal to 0.
   Otherwise (sb_coded_flag[xS][yS] is equal to 1), the following applies:
      If (xS, yS) is equal to (0, 0) and (LastSignificantCoeffX, LastSignificantCoeffY) is not equal to (0, 0), at least one of the sig coeff flag syntax elements is present for the subblock at location (xS, yS).
      Otherwise, at least one of the transform coefficient levels of the subblock at location (xS, yS) has a non-zero value.
Otherwise (transform skip flag[x0][y0][cIdx] is equal to 1 and sh_ts_residual_coding_disabled_flag is equal to 0), the following applies:
   When sb_coded_flag[xS][yS] is not present, it is inferred to be equal to 1.
   If sb_coded_flag[xS][yS] is equal to 0, the transform coefficient levels of the subblock at location (xS, yS) are inferred to be equal to 0.
   Otherwise (sb_coded_flag[xS][yS] is equal to 1), at least one of the transform coefficient levels of the subblock at location (xS, yS) has a non-zero value.

With the proposed semantics, subblock flags associated with the first subblock and the subblock containing the last significant coefficient are still inferred to be 1. However, subblock flags associated with subblocks in scanning order after the subblock containing the last significant coefficient are instead inferred to be 0.

As described above with reference to Eqns. (9), (10), (12) and (13), this change in inference rule affects the determination of the context index for sb_coded_flag when it is coded. In particular, “Context A” becomes more likely to be selected. Which context index is selected affects the arithmetic decoding process of sb_coded_flag in two ways. Firstly, when sb_coded_flag is first decoded from the bitstream for a slice, the context states are first initialised according to predefined values for the selected context index. Secondly, every subsequent time sb_coded_flag is decoded from the bitstream, the context index fetches a context which has had its states updated and refined by coding of previous sb_coded_flag syntax elements which corresponded to the same context index. In this disclosure, context adaptive binary arithmetic coding (CABAC), arithmetic coding, and entropy coding may be understood as equivalent terms. Moreover a context may be understood to also refer to its context states, or the associated entropy coding model that these states represent.

The proposed change in the inference rule affects the context index for sb_coded_flag when at least one of the neighbouring sb_coded_flag to the right or below are inferred, which means that it affects the decoding of sb_coded_flag syntax elements that are early in coding order. The subblock flags are coded in reverse diagonal scan order, which means that subblock flags associated with subblocks containing transform coefficients for higher frequency are coded first. Such subblocks are less likely to contain significant coefficients and thus the subblock flags are more likely to be 0.

In the context initialisation derivation process, this may result in context states being initialised which assume a higher probability of sb_coded_flag having the value 0. In such case, sb_coded_flag is more efficiently encoded if it does have the value 0, and less efficiently coded if it has the value 1. On average, sb_coded_flag will be more efficiently coded since the value 0 is more likely to occur for a subblock containing transform coefficients for high frequency.

On subsequent decoding of sb_coded_flag, the change in the inference rule may cause context states to be fetched which have been updated and refined by coding of previous sb_coded_flag syntax elements where the neighbouring sb_coded_flag syntax elements to the right and below had the value 0. Similarly, this may result in context states being fetched which have been adapted to a higher probability of sb_coded_flag having the value 0. Therefore again, on average the sb_coded_flag will be more efficiently coded since the value 0 is more likely to occur for a subblock containing transform coefficients for high frequency.

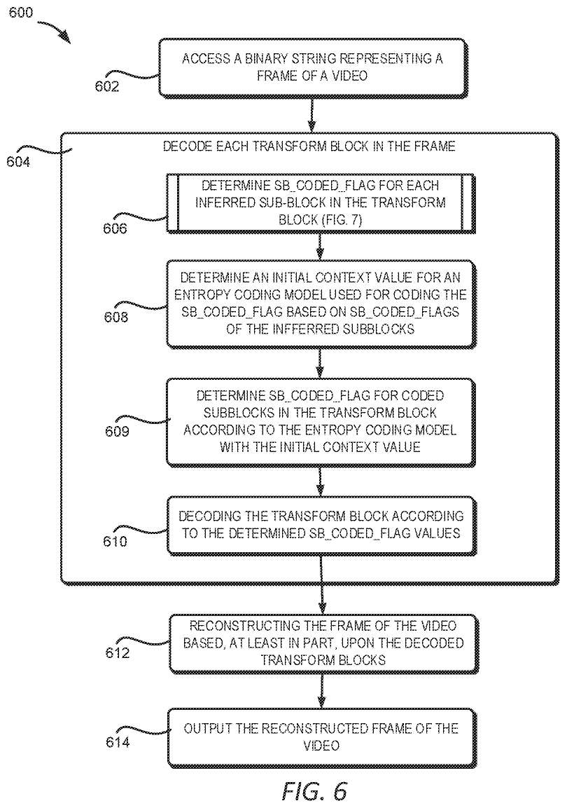

FIG. 6 depicts an example of a process 600 for decoding a video, according to some embodiments of the present disclosure. One or more computing devices implement operations depicted in FIG. 6 by executing suitable program code. For example, a computing device implementing the video decoder 200 may implement the operations depicted in FIG. 6 by executing the program code for the entropy decoding module 216, the inverse quantization module 218, and the inverse transform module 219. For illustrative purposes, the process 600 is described with reference to some examples depicted in the figures. Other implementations, however, are possible.

At block 602, the process 600 involves accessing, from a video bitstream of a video signal, a binary string or a binary representation that represents a frame of the video. The frame may be divided into slices or tiles or any type of partition processed by a video encoder as a unit when performing the encoding. The frame can include a set of CTUs as shown in FIG. 3. Each CTU includes one or more CUs as shown in the example of FIG. 4 and each CU may contain one or more transform blocks for encoding.

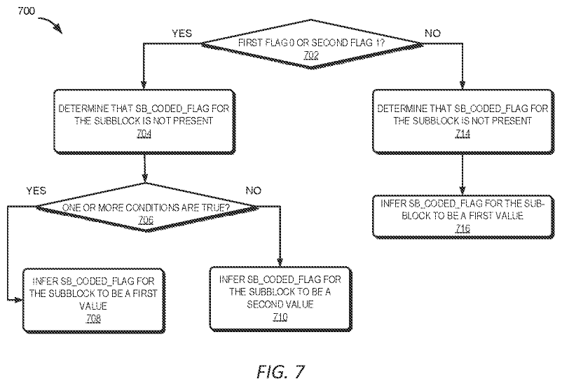

At block 604, which includes 606-610, the process 600 involves decoding each transform block of the frame from the binary string to generate decoded samples for the transform block. At block 606, the process 600 involves determining the subblock flag sb_coded_flag for each inferred subblock in the transform block. Details regarding the determination of the subblock flags are presented with respect to FIG. 7.

At block 608, the process 600 involves determining an initial context value for an entropy coding model for coding the subblock flags. As discussed above in detail, a context index increment ctxInc is determined, depending on the value of inferred subblock flags to the right and below of a first coded subblock flag. The initial context value of the entropy coding model can then be determined by deriving an index to a context state table based on the context index increment ctxInc and retrieving the initial context value from the context state table. At block 609, the process 600 involves decoding the subblock flag sb_coded_flag for each coded flag in the transform block, with the first coded subblock flag being decoded using the initial context value, and subsequent coded subblock flags being decoded using context values updated from the initial context value. At block 610, the process 600 involves decoding the transform block by decoding a portion of the binary string that corresponds to the transform block. The decoding can include decoding transform coefficient levels for subblocks in the transform block with an inferred or decoded sb_coded_flag value of 1. The decoding can further include inferring transform coefficient levels as 0 for subblocks in the transform block with an inferred or decoded sb_coded_flag value of 0. The decoding can further include reconstructing the samples of the subblocks through, for example, inverse quantization, inverse transformation (if needed), inter- and/or intra-prediction as discussed above with respect to FIG. 2.

At block 612, the process 600 involves reconstructing the frame of the video based on the decoded transform blocks. At block 614, the process 600 involves outputting the decoded frame of the video along with other decoded frames of the video for display.

FIG. 7 depicts an example of a process 700 for determining the value of subblock flag for each subblock in a transform block, according to some embodiments of the present disclosure. One or more computing devices implement operations depicted in FIG. 7 by executing suitable program code. For example, a computing device implementing the video decoder 200 may implement the operations depicted in FIG. 7 by executing the proper program code. For illustrative purposes, the process 700 is described with reference to some examples depicted in the figures. Other implementations, however, are possible.

At block 702, the process 700 involves determining whether a first flag specifying whether a transform is applied to the transform block is 0, or a second flag specifying whether the transform skip residual coding process is disabled is equal to 1. In some examples, the first flag is transform_skip_flag[x0][y0][cIdx] and the second flag is sh_ts_residual_coding_disabled_flag. transform_skip_flag[x0][y0][cIdx] specifies whether a transform is applied to the associated transform block or not. The array indices x0, y0 specify the location (x0, y0) of the top-left luma sample of the considered transform block relative to the top-left luma sample of the picture or frame. The array index cIdx specifies an indicator for the colour component; it is equal to 0 for Y, 1 for Cb, and 2 for Cr. transform_skip_flag[x0][y0][cIdx] equal to 1 specifies that no transform is applied to the associated transform block. transform_skip_flag[x0][y0][cIdx] equal to 0 specifies that the decision whether transform is applied to the associated transform block or not depends on other syntax elements. sh_ts_residual_coding_disabled_flag equal to 1 specifies that the residual_coding( ) syntax structure is used to parse the residual samples of a transform skip block for the current slice. sh_ts_residual_coding_disabled_flag equal to 0 specifies that the residual_ts_coding( ) syntax structure is used to parse the residual samples of a transform skip block for the current slice. When sh_ts_residual_coding_disabled_flag is not present, it is inferred to be equal to 0.

If the first flag is equal to 0 or the second flag is equal to 1 (which indicates that the transform block is encoded with RRC), the process 700 involves, at block 704, determining that the subblock flag sb_coded_flag for the current subblock is not present in the binary string for the frame. At block 706, the process 700 involves determining whether one or more of two conditions are true. The two conditions include a first condition that the subblock is a DC subblock (e.g., (xS, yS) is equal to (0, 0)) and a second condition that the subblock is a last subblock in the transform block containing a non-zero coefficient level. The second condition can be checked by determining whether (xS, yS) is equal to (LastSignificantCoeffX>>log 2SbW, LastSignificantCoeffY>>log 2SbH). Here, (xS, yS) is the current subblock scan location, LastSignificantCoeffX and LastSignificantCoeffY are the coordinates of the last significant coefficient (e.g., last non-zero coefficient) of the transform block. log 2TbWidth and log 2TbHeight are the binary logarithm of the transform block width and the transform block height, respectively.

If one or more of the two conditions are true, the process 700 involves, at block 708, inferring the subblock flag for the current subblock (xS, yS) to be a first value, such as 1, to indicate that the current subblock has at least one non-zero transform coefficient level. Otherwise, the process 700 involves, at block 710, inferring the subblock flag for the current subblock (xS, yS) to be a second value, such as 0, to indicate that all transform coefficient levels in the current subblock can be inferred to be 0.

If the first flag is equal to 1 and the second flag is equal to 0 (which indicates that the transform block is encoded with TSRC), the process 700 involves, at block 714, determining that the subblock flag sb_coded_flag for the current subblock is not present in the binary string for the frame. At block 716, the process 700 involves inferring the flag sb_coded_flag for the subblock to be the first value (e.g., 1). The flag having the first value indicates that at least one of the transform coefficient levels of the subblock has a non-zero value.

### Computing System Example

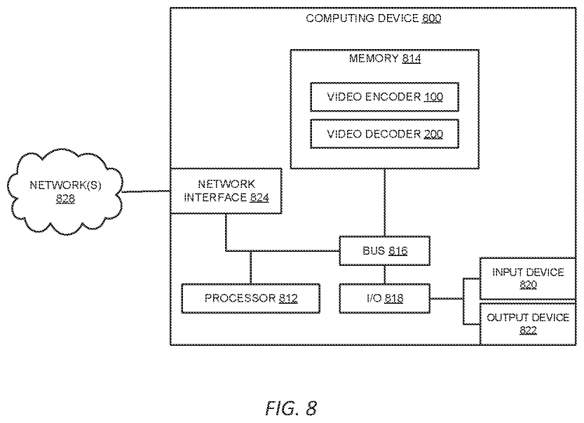

Any suitable computing system can be used for performing the operations described herein. For example, FIG. 8 depicts an example of a computing device 800 that can implement the video encoder 100 of FIG. 1 or the video decoder 200 of FIG. 2. In some embodiments, the computing device 800 can include a processor 812 that is communicatively coupled to a memory 814 and that executes computer-executable program code and/or accesses information stored in the memory 814. The processor 812 may comprise a microprocessor, an application-specific integrated circuit (“ASIC”), a state machine, or other processing device. The processor 812 can include any of a number of processing devices, including one. Such a processor can include or may be in communication with a computer-readable medium storing instructions that, when executed by the processor 812, cause the processor to perform the operations described herein.

The memory 814 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 800 can also include a bus 816. The bus 816 can communicatively couple one or more components of the computing device 800. The computing device 800 can also include a number of external or internal devices such as input or output devices. For example, the computing device 800 is shown with an input/output (“I/O”) interface 818 that can receive input from one or more input devices 820 or provide output to one or more output devices 822. The one or more input devices 820 and one or more output devices 822 can be communicatively coupled to the I/O interface 818. The communicative coupling can be implemented via any suitable manner (e.g., a connection via a printed circuit board, connection via a cable, communication via wireless transmissions, etc.). Non-limiting examples of input devices 820 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 822 include an LCD screen, an external monitor, a speaker, or any other device that can be used to display or otherwise present outputs generated by a computing device.

The computing device 800 can execute program code that configures the processor 812 to perform one or more of the operations described above with respect to FIGS. 1-7. The program code can include the video encoder 100 or the video decoder 200. The program code may be resident in the memory 814 or any suitable computer-readable medium and may be executed by the processor 812 or any other suitable processor.

The computing device 800 can also include at least one network interface device 824. The network interface device 824 can include any device or group of devices suitable for establishing a wired or wireless data connection to one or more data networks 828. Non-limiting examples of the network interface device 824 include an Ethernet network adapter, a modem, and/or the like. The computing device 800 can transmit messages as electronic or optical signals via the network interface device 824.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into subblocks. Some blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for decoding a video bitstream, the method comprising:
determining a flag sb_coded_flag for a subblock of a current transform block, determining the flag sb_coded_flag comprising:
determining whether a first flag specifying whether a transform skip is applied to the transform block is 0 or a second flag specifying whether a transform skip residual coding process is disabled is equal to 1,
in response to determining that the first flag is equal to 0 or the second flag is equal to 1,
in response to determining that the flag sb_coded_flag for the subblock is not present,
inferring the flag sb_coded_flag for the subblock to be a first value in response to determining one or more conditions are true, the conditions comprising a first condition that the subblock is a DC subblock and a second condition that the subblock is a last subblock in the transform block containing a non-zero coefficient level, or
inferring the flag sb_coded_flag for the subblock to be a second value in response to determining that the conditions are not true,
in response to determining that the flag sb_coded_flag for the subblock is present,
determining a context index for an arithmetic decoding process used for decoding the flag sb_coded_flag for the subblock based, at least in part, upon flags sb_coded_flag of previous subblocks,
decoding the flag sb_coded_flag for the subblock according to the arithmetic decoding process with the determined context index; and
decoding the transform block by decoding at least a portion of the bitstream based on the determined flag sb_coded_flag.

2. The method of claim 1, wherein the first flag is transform_skip_flag[x0][y0][cIdx] and the second flag is sh_ts_residual_coding_disabled_flag, wherein (x0, y0) specifies a luma location of a top-left sample of the transform block relative to a top-left sample of the frame, and cIdx is a colour component index.

3. The method of claim 1, wherein determining that the first condition is true comprises determining that an index for the subblock (xS, yS) is equal to (0,0).

4. The method of claim 1, wherein determining that the second condition is true comprises determining that a scan location of the subblock (xS, yS) is equal to (LastSignificantCoeffX>>log 2SbW, LastSignificantCoeffY>>log 2SbH), where LastSignificantCoeffX denotes a position of a last significant coefficient in the transform block in a horizontal direction, LastSignificantCoeffY denotes a position of the last significant coefficient in the transform block in a vertical direction, log 2SbW denotes a binary logarithm of a width of the subblock, and log 2SbH denotes a binary logarithm of a height of the subblock.

5. The method of claim 1, wherein the first value is 1 and the second value is 0.

6. The method of claim 1, wherein determining the context index for the arithmetic decoding process comprises:
determining a variable csbfCtx based on a location of the subblock (xS, yS), decoded sb_coded_flags for previous subblocks in a scan order, a width of the transform block, and a height of the transform block;
determining a context index increment ctxInc based on the variable csbfCtx; and
determining the context index for the arithmetic decoding process using the context index increment ctxInc.

7. The method of claim 6, wherein the previous subblocks in the scan order comprises a first neighbouring subblock on a right side of the subblock and a second neighbouring subblock below the subblock.

8. A non-transitory computer-readable medium having program code that is stored thereon, the program code executable by one or more processing devices for performing operations comprising:
determining a flag sb_coded_flag for a subblock of a current transform block, determining the flag sb_coded_flag comprising:
determining whether a first flag specifying whether a transform skip is applied to the transform block is 0 or a second flag specifying whether a transform skip residual coding process is disabled is equal to 1,
in response to determining that the first flag is equal to 0 or the second flag is equal to 1,
in response to determining that the flag sb_coded_flag for the subblock is not present,
inferring the flag sb_coded_flag for the subblock to be a first value in response to determining one or more conditions are true, the conditions comprising a first condition that the subblock is a DC subblock and a second condition that the subblock is a last subblock in the transform block containing a non-zero coefficient level, or
inferring the flag sb_coded_flag for the subblock to be a second value in response to determining that the conditions are not true,
in response to determining that the flag sb_coded_flag for the subblock is present,
determining a context index for an arithmetic decoding process used for decoding the flag sb_coded_flag for the subblock based, at least in part, upon the flags sb_coded_flag of previous subblocks,
decoding the flag sb_coded_flag for the subblock according to the arithmetic decoding process with the determined context index; and
decoding the transform block by decoding at least a portion of the bitstream based on the determined flag sb_coded_flag.

9. The non-transitory computer-readable medium of claim 8, wherein the first flag is transform_skip_flag[x0][y0][cIdx] and the second flag is sh_ts_residual_coding_disabled_flag, wherein (x0, y0) specifies a luma location of a top-left sample of the transform block relative to a top-left sample of the frame, and cIdx is a colour component index.

10. The non-transitory computer-readable medium of claim 8, wherein determining that the first condition is true comprises determining that an index for the subblock (xS, yS) is equal to (0,0).

11. The non-transitory computer-readable medium of claim 8, wherein determining that the second condition is true comprises determining that a scan location of the subblock (xS, yS) is equal to (LastSignificantCoeffX>>log 2SbW, LastSignificantCoeffY>>log 2SbH), where LastSignificantCoeffX denotes a position of the last significant coefficient in the transform block in a horizontal direction, LastSignificantCoeffY denotes a position of the last significant coefficient in the transform block in a vertical direction, log 2SbW denotes a binary logarithm of a width of the subblock, and log 2SbH denotes a binary logarithm of a height of the subblock.

12. The non-transitory computer-readable medium of claim 8, wherein the first value is 1 and the second value is 0.

13. The non-transitory computer-readable medium of claim 8, wherein determining the context index for the arithmetic decoding process comprises:
determining a variable csbfCtx based on a location of the subblock (xS, yS), decoded sb_coded_flags for previous subblocks in a scan order, a width of the transform block, and a height of the transform block;
determining a context index increment ctxInc based on the variable csbfCtx; and
determining the context index for the arithmetic decoding process using the context index increment ctxInc.

14. The non-transitory computer-readable medium of claim 13, wherein the previous subblocks in the scan order comprises a first neighbouring subblock on a right side of the subblock and a second neighbouring subblock below the subblock.

15. A system comprising:
a processing device; and
a non-transitory computer-readable medium communicatively coupled to the processing device, wherein the processing device is configured to execute program code stored in the non-transitory computer-readable medium and thereby perform operations comprising:
determining a flag sb_coded_flag for a subblock of a current transform block,
determining the flag sb_coded_flag comprising:
determining whether a first flag specifying whether a transform skip is applied to the transform block is 0 or a second flag specifying whether a transform skip residual coding process is disabled is equal to 1,
in response to determining that the first flag is equal to 0 or the second flag is equal to 1,
in response to determining that the flag sb_coded_flag for the subblock is not present,
inferring the flag sb_coded_flag for the subblock to be a first value in response to determining one or more conditions are true, the conditions comprising a first condition that the subblock is a DC subblock and a second condition that the subblock is a last subblock in the transform block containing a non-zero coefficient level, or
inferring the flag sb_coded_flag for the subblock to be a second value in response to determining that the conditions are not true,
in response to determining that the flag sb_coded_flag for the subblock is present,
determining a context index for an arithmetic decoding process used for decoding the flag sb_coded_flag for the subblock based, at least in part, upon the flags sb_coded_flag of previous subblocks,
decoding the flag sb_coded_flag for the subblock according to the arithmetic decoding process with the determined context index; and
decoding the transform block by decoding at least a portion of the bitstream based on the determined flag sb_coded_flag.

16. The system of claim 15, wherein the first flag is transform_skip_flag[x0][y0][cIdx] and the second flag is sh_ts_residual_coding_disabled_flag, wherein (x0, y0) specifies a luma location of a top-left sample of the transform block relative to a top-left sample of the frame, and cIdx is a colour component index.

17. The system of claim 15, wherein determining that the first condition is true comprises determining that an index for the subblock (xS, yS) is equal to (0,0).

18. The system of claim 15, wherein determining that the second condition is true comprises determining that a scan location of the subblock (xS, yS) is equal to (LastSignificantCoeffX>>log 2SbW, LastSignificantCoeffY>>log 2SbH), where LastSignificantCoeffX denotes a position of the last significant coefficient in the transform block in a horizontal direction, LastSignificantCoeffY denotes a position of the last significant coefficient in the transform block in a vertical direction, log 2SbW denotes a binary logarithm of a width of the subblock, and log 2SbH denotes a binary logarithm of a height of the subblock.

19. The system of claim 15, wherein determining the context index for the arithmetic decoding process comprises:
determining a variable csbfCtx based on a location of the subblock (xS, yS), decoded sb_coded_flags for previous subblocks in a scan order, a width of the transform block, and a height of the transform block;
determining a context index increment ctxInc based on the variable csbfCtx; and
determining the context index for the arithmetic decoding process using the context index increment ctxInc.

20. The system of claim 19, wherein the previous subblocks in the scan order comprises a first neighbouring subblock on a right side of the subblock and a second neighbouring subblock below the subblock.
